(19) United States
(12) Patent Application Publication
(10) Pub. No.: US 2005/0087987 A1
(43) Pub. Date: Apr. 28, 2005

(54) [HOUSEHOLD EMERGENCY POWER GENERATOR]

(75) Inventor: CHUN-MING KUO, TAIPEI (TW)

Correspondence Address: CHUN-MING KUO, 2F-4, NO. 148, SEC. 4, CHUNG HSIAO E. ROAD, TAIPEI, TW

(73) Assignee: Mr. CHUN-MING KUO, TAIPEI (TW)

(21) Appl. No.: 10/605,749

(22) Filed: Oct. 23, 2003

(51) Int. Cl. H02P 9/04

(52) U.S. Cl. 290/1 A

(57) ABSTRACT

A household emergency power generator is described. The generator set uses gas as the fuel. Accordingly, the gas fuel can be supplied to the generator set through the general gas supply pipeline, therefore the disadvantages of storing oil fuel and the risk thereof can be effectively eliminated. The generator set is equipped with an automatic transfer switch (ATS). When the general power cut occurs, the ATS automatically supplies gas to the generator set to set it into an operation mode to generate power for supplying to the power supply circuit, and when the general power is restored, the ATS cuts the gas supply to stop the generator set. Thus, the power supply to the power supply circuit remains uninterrupted.

### BACKGROUND OF INVENTION

1. The Field of the Invention

The present invention relates to a household emergency power generator, and more particularly to a household emergency power generator that use gas as the fuel. The emergency power generator comprises an automatic transfer switch (ATS) that can start the generator set to generate power when a power cut occurs.

2. Description of the Related Art

For dealing with the temporary power cut, some inventors created a power generator, which use oil as the fuel. Such conventional power generator uses the oil to run the power generator for generating power, however, larger volume of the fuel is required for a long operation hours. Besides, such power generator requires pipe-work, which requires skilled technicians, and therefore the conventional power generator is expensive and not suitable for household use. Further, if there is no suitable place for storing the oil, then the use of the conventional power generator is practically useless in such locations. Because the oil is highly flammable, there is a high risk that it could easily catch fire or even explode. On the other hand, it is very inconvenient to travel to the oil supplier to purchase the oil when power cut occurs. Nowadays, the abovementioned power generator is mostly applied in industrial field and the users thereof usually are located in the places where there is insufficient power supply, and therefore, when during a natural disaster scenario, for example, a storm, causing power cut over a long period of time, the abovementioned power generator may not be able to supply sufficient power for operating critical equipment, for example, heater, during the winter season, may result in loss of life. So how to solve the above defects of the conventional power generator is a very important issue for the manufacturers in the field.

### SUMMARY OF INVENTION

Accordingly, in the view of the foregoing, the present inventor makes a detailed study of related art to evaluate and consider, and uses years of accumulated experience in this field, and through several experiments, to create a household emergency power generator. The present invention provides an innovated cost effective household emergency power generator.

According to an aspect of the present invention, the generator set uses gas as the fuel. Accordingly, the gas fuel can be supplied to the generator set through the general gas fuel pipeline, therefore the disadvantages of storing oil fuel and the risk thereof can be effectively eliminated.

According to another aspect of the present invention, the generator set is equipped with an automatic transfer switch (ATS). When the general power cut occurs, the ATS can automatically supply gas to the generator set to set it into an operation mode to generate power, and when the main power is restored, the ATS cuts the gas supply so that the generator set stops operating.

According to another aspect of the present invention, the ATS connecting to the generator set is capable of simplifying the external circuit facilitating easy installation of the device.

### BRIEF DESCRIPTION OF DRAWINGS

For a more complete understanding of the present invention, reference will now be made to the following detailed description of preferred embodiments taken in conjunction with the accompanying drawings.

FIG. 1 is a view of the household emergency power generator of the present invention.

FIG. 2 is a view of the ATS of the household emergency power generator of the present invention.

### DETAILED DESCRIPTION

Reference will be made in detail to the preferred embodiments of the invention, examples of which are illustrated in the accompanying drawings. Wherever possible, the same reference numbers are used in the drawings and the description to refer to the same or like parts.

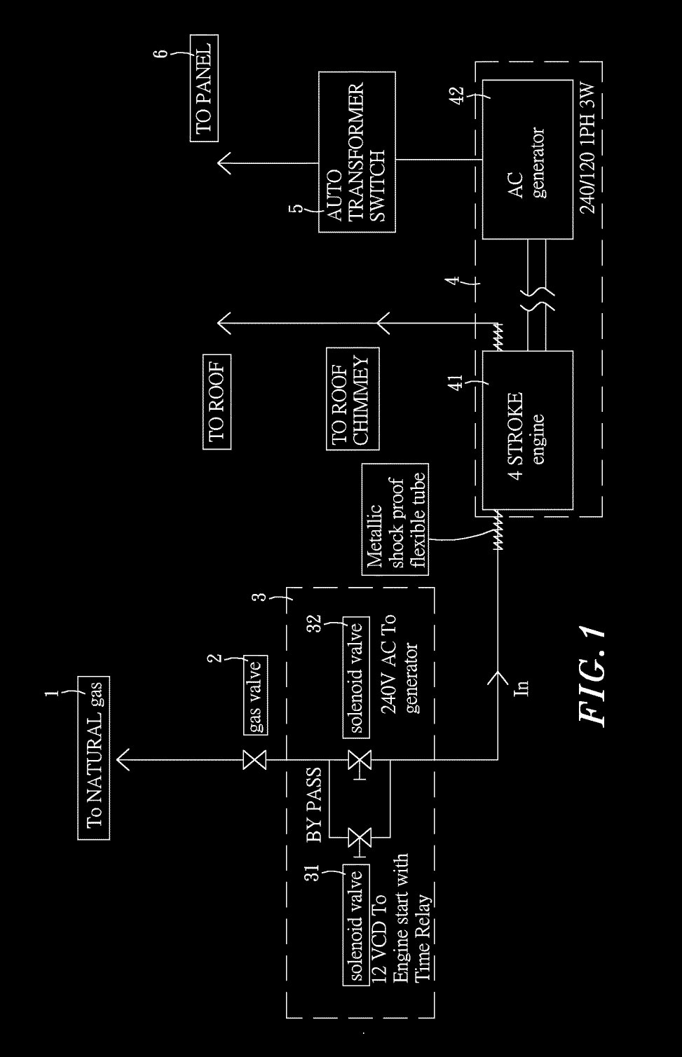

Referring to FIG. 1, the view of the household emergency power generator of the present invention is shown. The household emergency power generator of the present invention comprises a gas fuel pipeline 1, a manual control valve 2, a solenoid 3, a generator set 4, an ATS 5 and a power circuit 6. The gas fuel pipeline 1 can be used for supplying gas or liquefied natural gas.

The manual control valve 2 is installed on the gas fuel pipeline 1 for opening or closing the gas fuel pipeline 1. The manual control valve 2 is opened in the normal situation and will be closed during maintenance or installation.

The solenoid 3 is connected to the manual control valve 2. The solenoid 3 comprises a main solenoid 32, which is equipped with a solenoid actuator 31.

The generator set 4 is connected to the solenoid 3. The generator set 4 comprises an engine 41, which is equipped with a generator 42.

The ATS 5 is connected to the generator 42 of the generator set 4. The generator set 4 can control the ATS 5 to be operated automatically, manually or semi-automatically.

The power circuit 6 is connected to the ATS 5 for controlling power loading.

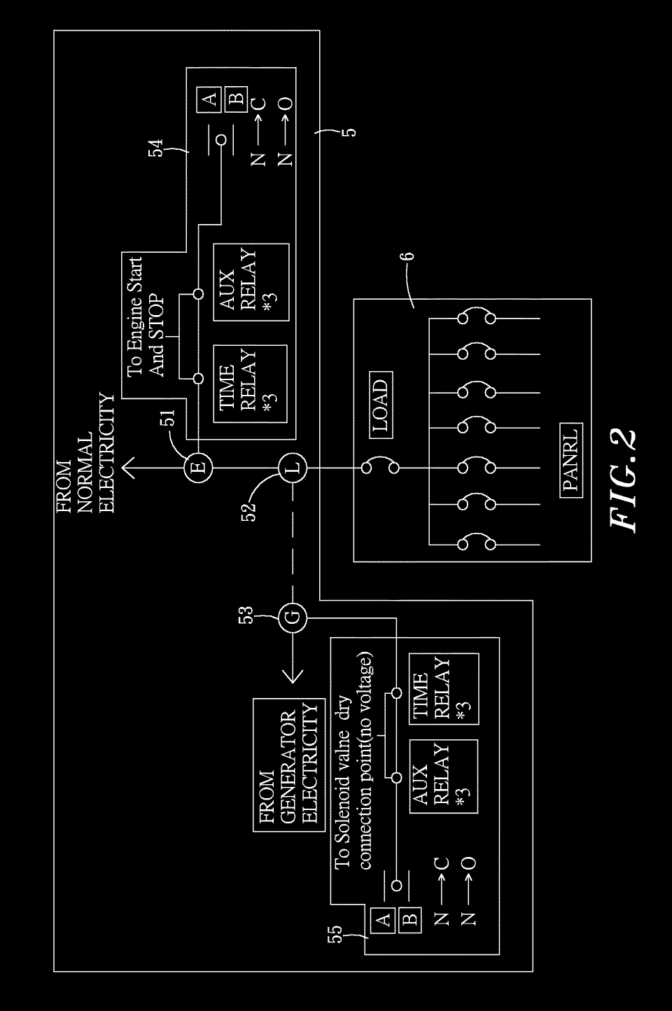

Now, referring to FIG. 2, the view of the ATS of the household emergency power generator of the present invention is shown. As shown in FIG. 2, the ATS 5 comprises a power supply end 51, a loading end 52 and a generator end 53.

The power supply end 51 is connected to the regular power supply circuit. The power supply end 51 comprises a first timer relay and AUX, relay 54.

The loading end 52 is connected to the power circuit 6.

The generator 53 is connected to the generator set 4. The generator 53 comprises a second timer relay and AUX, relay 55.

Referring to FIGS. 1 and 2, during the regular power supply, the regular power supply circuit transfers the power to the power circuit 6 through the ATS 5. When the power cut occurs, the first timer relay and AUX, relay 54 will send a signal to notify the second timer relay and AUX, relay 55 to activate the second timer relay and AUX, relay 55 to open the solenoid actuator 31 and the engine 41 of the generator set 4 to lead the gas into the engine 41 so that the engine 41 begins to operate. After the engine 41 begins to operate, the second timer relay and AUX, relay 55 will close the solenoid actuator 31 and open the main solenoid 32 for switching the gas supplier to the main solenoid 32 to continue gas supply to engine 41. Next, the engine 41 starts the generator 42 to generate the power that is transferred the power to the power circuit 6 through the generator end 53 and loading end 52 of the ATS 5. When the regular power supply restored, the first timer relay and AUX, relay 54 will shut down the engine 41 to stop the operation of the generator 42, meanwhile the main solenoid 32 is closed and the regular power supply circuit will continue to transfer the power to the power circuit 6 through the power supply end 51 and the loading end 52 of the ATS 5. Therefore the power supply to the power circuit 6 is uninterrupted.

Accordingly, the household emergency power generator of the present of the present invention has at least the following advantages.

The generator set 4 uses gas fuel, and therefore the user can use the usual gas pipeline to generate the power without requiring the use of oil or storage of oil so that the inconvenience of oil purchase, storage of oil can be effectively eliminated and the risk of fire or explosion hazard due to oil storage can be effectively reduced or eliminated.

The generator set 4 is connecting to the ATS 5, thus the generator set 4 can operate automatically for supplying power when the power is off, and the ATS 5 will stop the operation of the generator set 4 when the power is back on supplying, meanwhile, the main solenoid 32 will be closed to continue the power supply by the regular power supply circuit.

The household emergency power generator of the present invention equipped with the ATS 5 only needs a gas fuel pipeline 1 to connect with the generator set 4, and therefore the assembly thereof merely requires setting the solenoid 3 on the gas fuel pipeline 1, connecting the gas fuel pipeline 1 to the generator set 4 and connecting the power supply circuit 6 to the ATS 5.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and nonlimiting sense.

1. A household emergency power generator, using a gas fuel to generate power, comprising:
a gas fuel pipeline;
a solenoid, installed on said gas fuel pipeline for controlling closing or opening thereof;
a generator set, connected to said solenoid, wherein said generator set comprises an engine, which connected to a generator; and
an automatic transfer switch, connected to a power circuit of said generator set, wherein when power cut occurs, said automatic transfer switch of said emergency power supplier switches to said generator set to supply the gas fuel to said generator set through said gas fuel pipeline to operate said generator set for generating power.

2. The household emergency power generator according to claim 1, wherein said gas fuel is a natural gas.

3. The household emergency power generator according to claim 1, wherein said gas fuel is a liquefied natural gas.

4. The household emergency power generator according to claim 1, wherein said automatic transfer switch comprises a timer relay, and wherein when the regular power supply is cut, said timer relay automatically activates said generator set for generating power, and when the regular power supply is restored, said timer relay automatically stops the operation of said generator set.

5. The household emergency power generator according to claim 1, wherein said automatic transfer switch can switch to an automatic operation mode.

6. The household emergency power generator according to claim 1, wherein said automatic transfer switch can switch to a manual operation mode.

7. The household emergency power generator according to claim 1, wherein said automatic transfer switch can switch to a semi-automatic operation mode.
